(19) United States
(12) Patent Application Publication
(10) Pub. No.: US 2020/0142985 A1
(43) Pub. Date: May 7, 2020

(54) ASYNCHRONOUSLY PUBLISHING EVENTS TO A MESSAGE BUS IN AN EVENT-DRIVEN COMPUTING SYSTEM

(71) Applicant: Zendesk, Inc., San Francisco, CA (US)

(72) Inventor: Likun Liu, San Francisco, CA (US)

(73) Assignee: Zendesk, Inc., San Francisco, CA (US)

(21) Appl. No.: 16/183,501

(22) Filed: Nov. 7, 2018

(51) Int. Cl. G06F 17/30; G06F 13/20

(52) U.S. Cl. CPC G06F 17/30371; G06F 13/20; G06F 17/30578

(57) ABSTRACT

The disclosed embodiments relate to a system that publishes an event to a message bus in an event-driven computing system. During operation, the system executes event-producing code, which detects an event, wherein the event results in one or more writes to a database system, and wherein success of the one or more writes defines whether the event took place. In response to detecting the event, the system writes the event to temporary storage, which is maintained by the database system, wherein the database system automatically reclaims the temporary storage without requiring additional clean up operations by the application. Next, the system executes event-publishing code, which asynchronously collects the event from the temporary storage, and publishes the event to the message bus.

### BACKGROUND

### Field

The disclosed embodiments generally relate to the design of event-driven computing systems. More specifically, the disclosed embodiments relate to a technique that improves the performance of an event-driven computing system by writing events from an event producer to temporary storage, which is maintained by a database, and then asynchronously publishing the events from the temporary storage to a message bus, which communicates the events to event consumers.

### Related Art

Event-driven architectures are increasingly being used to produce highly scalable software systems. Event-driven software systems are comprised of highly decoupled, event-processing modules, which asynchronously generate, receive and process events. In general, an event-driven architecture facilitates the production, detection and consumption of “events” and associated responses. An event-driven architecture includes both event producers and event consumers. Event producers are entities that detect an event, and indicate that the event has occurred. Event consumers are entities that need to know the event has occurred; they may be involved in processing the event or they may simply be affected by the event. Event consumers typically operate by monitoring a “message bus” or “streaming platform” such as Apache Kafka™, which carries events generated by event producers. The benefit of an event-driven architecture is that it makes it possible to easily integrate multiple systems, and scale up the application independently.

A challenge that arises in event-driven systems is that the message bus may be unavailable when an event needs to be published. In some cases, an event causes the event producer to perform writes to a database before publishing the event to a message bus, and the success or failure of the writes defines whether the event took place. In these cases, it is not sufficient to simply publish the event to the message bus after performing the associated writes to the database because the message bus may be unavailable, which means the event will not be delivered. If this occurs, it is hard (if not impossible) to guarantee consistency between the writes to the database and what is ultimately published to the message bus.

Hence, what is needed is a technique for ensuring consistency between what is written to a database and what is published to the message bus by an application in an event-driven software system.

### SUMMARY

The disclosed embodiments relate to a system that publishes an event to a message bus in an event-driven computing system. During operation, the system executes event-producing code for an application. This event-producing code detects an event, wherein the event results in one or more writes to a database system, and wherein success of the one or more writes defines whether the event took place. In response to detecting the event, the system writes the event to temporary storage, which is maintained by the database system. Next, the system executes event-publishing code, which asynchronously collects the event from the temporary storage, and publishes the event to the message bus.

In some embodiments, the database system automatically reclaims the temporary storage without requiring additional clean up operations by the application.

In some embodiments, after the event is published to the message bus, the one or more writes to the database system, which are associated with the event, and the published event comprise a transaction that satisfies atomicity, consistency, isolation and durability (ACID) properties.

In some embodiments, while publishing the event to the message bus, the system can send the event either synchronously or asynchronously with callback to confirm the success publishing of the event.

In some embodiments, the published event is received at an event consumer, which performs one or more operations in response to the event.

In some embodiments, the database system comprises a MySQL database, and the temporary storage comprises MySQL binlog events associated with a MySQL table created with a MySQL Blackhole storage engine.

In some embodiments, the message bus comprises an Apache Kafka™ distributed streaming platform.

In some embodiments, the event-publishing code executes on a background process.

In some embodiments, the event-driven computing system implements a help center and an associated ticketing system.

In some embodiments, events associated with the ticketing system include one or more of the following: a ticket-created event; a ticket-updated event; a ticket-solved event; a ticket-deleted event; a user-created event; a user-updated event; a user-deleted event; an account-created event; an account-updated event; an account-deleted event; a subscription-created event; a subscription-updated event; a subscription-deleted event; a help-center-article-published event; a help-center-article-updated event; and a help-center-article-deleted event.

### BRIEF DESCRIPTION OF THE FIGURES

FIG. 1 illustrates a computing environment including an application and an associated ticketing system in accordance with the disclosed embodiments.

FIG. 2 illustrates an exemplary event-driven computing system in accordance with the disclosed embodiments.

FIG. 3 presents a flow chart illustrating the process of asynchronously publishing an event in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

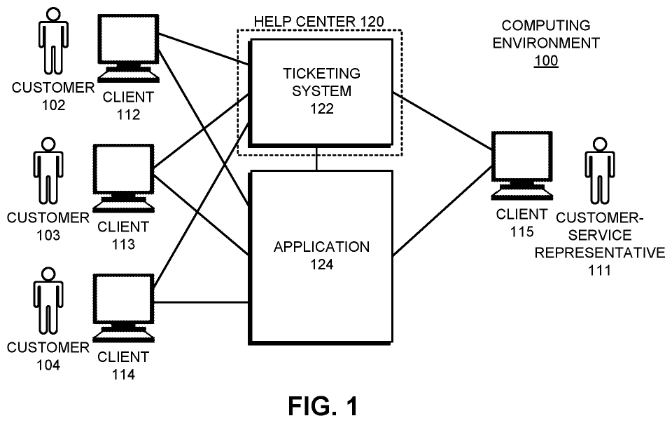

FIG. 1 illustrates an exemplary computing environment 100 in which the event-driven computing system operates. Computing environment 100 includes an application 124 and ticketing system 122 in accordance with the disclosed embodiments. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help center 120 to obtain help in dealing with issues, which can include various problems and questions. For example, a user of accounting software may need help in using a feature of the accounting software, or a customer of a website that sells sporting equipment may need help in cancelling an order that was erroneously entered. This help may be provided by a customer-service representative 111 who operates a client computer system 115 and interacts with customers 102-104 through help center 120. This help may also comprise automatically suggested helpful articles that the customer can read to hopefully resolve the problem or question. Note that customer-service representative 111 can access application 124 (either directly or indirectly through help center 120) to help resolve an issue.

In some embodiments, help center 120 is not associated with computer-based application 124, but is instead associated with another type of product or service that is offered to a customer. For example, help center 120 can provide assistance with a product, such as a television, or with a service such as a package-delivery service.

Help center 120 organizes customer issues using a ticketing system 122, which generates tickets to represent each customer issue. Ticketing systems are typically associated with a physical or virtual “help center” (or “help desk”) for resolving customer problems. Note that, although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

Many of the operations performed by help center 120 are controlled by an event-driven architecture, which is described in more detail below. Note that the technique for asynchronously publishing events, which is implemented by the disclosed embodiments, can be applied in many different event-driven systems, and is not meant to be limited to a help center or a ticketing system.

### Event-Driven Computing System

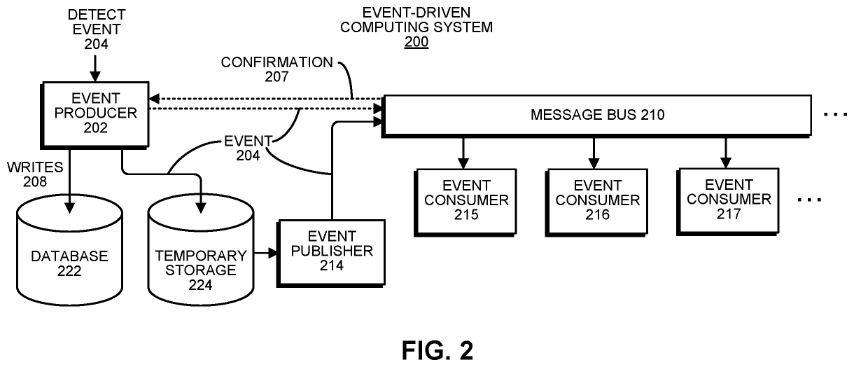

FIG. 2 illustrates an exemplary event-driven computing system 200 in accordance with the disclosed embodiments. As mentioned above, an event-driven computing system includes both event producers, such as event producer 202, and event consumers 215-217. Event producers are entities that detect an event, and indicate that the event has occurred. Event consumers 215-217 are entities that need to know the event has occurred; they may be involved in processing the event or they may simply be affected by the event. Event consumers 215-217 typically operate by monitoring a “message bus” or “streaming platform” such as Apache Kafka™, which carries events generated by event producers. In general, the term “message bus” can refer to any type of streaming platform or bus that can carry events, and is not limited to a specific streaming platform, such as Apache Kafka™.

As illustrated in FIG. 2, event-driven computing system 200 includes an event producer 202, which is a programming component that detects an event 204. (In general, event 204 can include any type of hardware-related or software-related occurrence, which can affect the execution of any component or system associated with event producer 202 and event consumers 215-217.) In addition to detecting the event, event producer 202 also performs one or more writes 208, which are associated with the event 204, to a database system 222, wherein success of the writes 208 defines whether the event took place. In response to detecting the event 204, event producer 202 writes event 204 to temporary storage 224. In general, temporary storage 224 can refer to any type of temporary storage that is maintained by a database system, which automatically reclaims the temporary storage 224, without requiring additional clean up operations by the application.

In some embodiments, temporary storage 224 is part of database system 222. For example, the database system 222 can comprise a MySQL database, and temporary storage 224 can comprise MySQL binlog events associated with a MySQL table created with a MySQL Blackhole storage engine.

Next, an event publisher 214, which is executing on a background process, asynchronously collects event 204 from temporary storage 224, and publishes event 204 to the message bus 210. Event publisher 214 can send the event either synchronously or asynchronously with callback to confirm the success publishing of the event. The published event subsequently propagates through message bus 210, which enables it to be received by event consumers 215-217.

Event producer 202 can alternatively send event 204 directly to message bus 210 as is indicated by the dashed line. However, in this case, event producer 202 has to wait to receive a confirmation 207 of the publication to ensure that the published event is consistent with the associated writes to database 222. Waiting for confirmation 207 reduces the performance of event producer 202, which can be especially burdensome in situations where message bus 210 becomes temporarily unavailable.

By providing a separate event publisher 214 to asynchronously publish events, the disclosed system avoids these performance problems. Moreover, by using temporary storage 224 to temporarily store these events, the system automatically reclaims the space in temporary storage 224, which is used to store the events, without requiring additional clean up operations by the application.

### Process of Asynchronously Publishing an Event

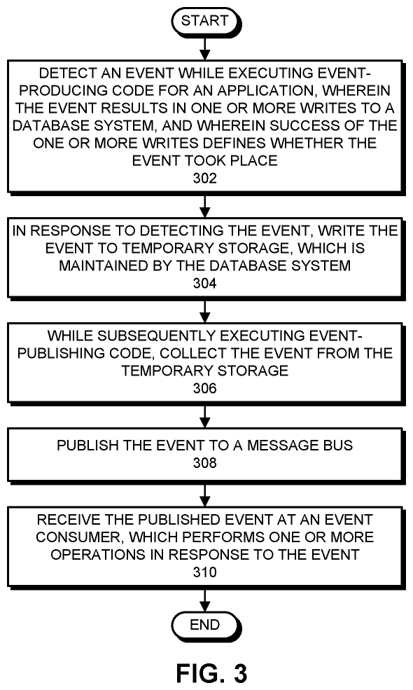

FIG. 3 presents a flow chart illustrating the process of asynchronously publishing an event in accordance with the disclosed embodiments. During operation of the system, the system detects an event while executing event-producing code for an application, wherein the event results in one or more writes to a database system, and wherein success of the one or more writes defines whether the event took place (step 302). In response to detecting the event, the system writes the event to temporary storage, which is maintained by the database system (step 304). Next, while executing event-publishing code, the system collects the event from the temporary storage (step 306), and publishes the event to a message bus (step 308). Finally, the system receives the published event at an event consumer, which performs one or more operations in response to the event (step 310).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for publishing an event to a message bus in an event-driven computing system, comprising:
executing event-producing code for an application in the event-driven computing system, wherein executing the event-producing code involves,
detecting an event, wherein the event results in one or more writes to a database system, and wherein success of the one or more writes defines whether the event took place, and
in response to detecting the event, writing the event to temporary storage, which is maintained by the database system, wherein the database system automatically reclaims the temporary storage without requiring additional clean up operations by the application; and
executing event-publishing code in the event-driven computing system, wherein executing the event-publishing code involves,
asynchronously collecting the event from the temporary storage, and
publishing the event to the message bus.

2. The method of claim 1, wherein after the event is published to the message bus, the one or more writes to the database system, which are associated with the event, and the published event comprise a transaction that satisfies ACID properties.

3. The method of claim 1, wherein while publishing the event to the message bus, the event-publishing code sends the event either synchronously or asynchronously with callback to confirm the success publishing of the event.

4. The method of claim 1, wherein the method further comprises receiving the published event at an event consumer, which performs one or more operations in response to the event.

5. The method of claim 1, wherein the database system comprises a MySQL database, and the temporary storage comprises MySQL binlog events associated with a MySQL table created with a MySQL Blackhole storage engine.

6. The method of claim 1, wherein the message bus comprises an Apache Kafka™ distributed streaming platform.

7. The method of claim 1, wherein the event-publishing code executes on a background process.

8. The method of claim 1, wherein the event-driven computing system implements a help center and an associated ticketing system.

9. The method of claim 8, wherein events associated with the ticketing system include one or more of the following:
a ticket-created event;
a ticket-updated event;
a ticket-solved event;
a ticket-deleted event;
a user-created event;
a user-updated event;
a user-deleted event;
an account-created event;
an account-updated event;
an account-deleted event;
a subscription-created event;
a subscription-updated event;
a subscription-deleted event;
a help-center-article-published event;
a help-center-article-updated event; and
a help-center-article-deleted event.

10. A non-transitory computer-readable storage medium storing instructions that when executed by a computer cause the computer to perform a method for publishing an event to a message bus in an event-driven computing system, the method comprising:
executing event-producing code for an application in the event-driven computing system, wherein executing the event-producing code involves,
detecting an event, wherein the event results in one or more writes to a database system, and wherein success of the one or more writes defines whether the event took place, and
in response to detecting the event, writing the event to temporary storage, which is maintained by the database system, wherein the database system automatically reclaims the temporary storage without requiring additional clean up operations by the application; and
executing event-publishing code in the event-driven computing system, wherein executing the event-publishing code involves,
asynchronously collecting the event from the temporary storage, and
publishing the event to the message bus.

11. The non-transitory computer-readable storage medium of claim 10, wherein after the event is published to the message bus, the one or more writes to the database system, which are associated with the event, and the published event comprise a transaction that satisfies ACID properties.

12. The non-transitory computer-readable storage medium of claim 10, wherein while publishing the event to the message bus, the event-publishing code sends the event either synchronously or asynchronously with callback to confirm the success publishing of the event.

13. The non-transitory computer-readable storage medium of claim 10, wherein the method further comprises receiving the published event at an event consumer, which performs one or more operations in response to the event.

14. The non-transitory computer-readable storage medium of claim 10, wherein the database system comprises a MySQL database, and the temporary storage comprises MySQL binlog events associated with a MySQL table created with a MySQL Blackhole storage engine.

15. The non-transitory computer-readable storage medium of claim 10, wherein the message bus comprises an Apache Kafka™ distributed streaming platform.

16. The non-transitory computer-readable storage medium of claim 10, wherein the event-publishing code executes on a background process.

17. The non-transitory computer-readable storage medium of claim 10, wherein the event-driven computing system implements a help center and an associated ticketing system.

18. The non-transitory computer-readable storage medium of claim 17, wherein events associated with the ticketing system include one or more of the following:
a ticket-created event;
a ticket-updated event;
a ticket-solved event;
a ticket-deleted event;
a user-created event;
a user-updated event;
a user-deleted event;
an account-created event;
an account-updated event;
an account-deleted event;
a subscription-created event;
a subscription-updated event;
a subscription-deleted event;
a help-center-article-published event;
a help-center-article-updated event; and
a help-center-article-deleted event.

19. An event-driven computing system, comprising:
at least one processor and at least one associated memory; and
an execution mechanism, which executes on the at least one processor, wherein during operation, the execution mechanism:
executes event-producing code for an application, wherein while executing the event-producing code, the execution mechanism,
detects an event, wherein the event results in one or more writes to a database system, and wherein success of the one or more writes defines whether the event took place, and
in response to detecting the event, writes the event to temporary storage, which is maintained by the database system, wherein the database system automatically reclaims the temporary storage without requiring additional clean up operations by the application; and
executes event-publishing code, wherein while executing the event-publishing code, the execution mechanism,
asynchronously collects the event from the temporary storage, and
publishes the event to the message bus.

20. The system of claim 19, wherein after the event is published to the message bus, the one or more writes to the database system, which are associated with the event, and the published event comprise a transaction that satisfies ACID properties.

21. The system of claim 19, wherein while publishing the event to the message bus, the event-publishing code sends the event either synchronously or asynchronously with callback to confirm the success publishing of the event.

22. The system of claim 19, wherein the published event is received at an event consumer, which performs one or more operations in response to the event.
